(19) United States
(12) Patent Application Publication
(10) Pub. No.: US 2012/0146437 A1
(43) Pub. Date: Jun. 14, 2012

(54) Apparatus For Converting Three Phase Electrical Power To Two Phase Electrical Power

(75) Inventor: Kent Kernahan, Cupertino, CA (US)

(73) Assignee: ArrayPower Inc., Sunnyvale, CA (US)

(21) Appl. No.: 13/315,019

(22) Filed: Dec. 8, 2011

Related U.S. Application Data
(60) Provisional application No. 61/422,725, filed on Dec. 14, 2010.

(51) Int. Cl. H02K 13/00

(52) U.S. Cl. 310/71

(57) ABSTRACT

Methods, apparatus and systems provide a rotary three-phase to two-phase converter. The converter may receive three phase electrical power in windings of a three phase induction motor. The motor may have a rotor and induction windings with three connections in parallel in a delta wiring configuration. Two of the connectors may be connected in parallel to a two phase load. In the various embodiments, switches may be controlled to optionally disconnect the load from the rotary converter. In various embodiments, the induction motor rotor may be free rotating, coupled to fly wheel or mechanically connected to a mechanical load.

### RELATED APPLICATIONS

This application claims priority to U.S. Provisional Patent Application 61/422,725 entitled “Apparatus for Converting Three Phase Electrical Power to Two Phase Electrical Power” filed Dec. 14, 2010, the entire contents of which are incorporated herein by reference. This application is also related to U.S. patent application Ser. No. 12/861,815 entitled “Three Phase Power Generation from a Plurality of Direct Current Sources” filed Aug. 23, 2010, the entire contents of which are incorporated herein by reference.

### FIELD OF THE INVENTION

The present invention relates generally to three-phase to two-phase electric current converters, and more particularly to a rotary three-phase to two-phase converter.

### BACKGROUND

Residential homes are typically provided two phase electrical power by a utility. The most usual arrangement is for high voltage three phase power to be delivered to a neighborhood by the power grid. A transformer in the neighborhood lowers the voltage to the level usable by the residence. In some cases, three phase electricity is distributed throughout an area but only two of the three phases are provided to a given home. In other systems, two phase power is distributed. Homes are provided with panel boxes with two power bus bars. One grid phase is connected to each bus bar. In the United States devices requiring approximately 110 VAC (RMS) are wired to one bus bar or the other and a neutral connection though a circuit breaker (or fuse in older homes) and a device requiring approximately 220 VAC (RMS) is wired across both bus bars.

Due to the prominence of two phase (often called an “Edison system”) systems in residential areas, many home power generation systems (e.g., solar panels) are equipped with one or more electrical inverters designed to provide two phase power. The power, when available, is then provided to local loads and/or optionally to the power grid. Some newer power generation systems output three phase electricity through power converters.

In some circumstances three phase electrical power is advantageous, such as providing electrical power to high power motors. A motor-generator in which a two phase motor drives a three phase generator is often used to generate the three-phase current for this purposes. In a similar fashion, a three phase electrical source could drive a two-phase motor coupled to a two phase generator, but there would be extra losses associated with such a system.

### SUMMARY

In the various embodiments, a rotary three-phase to two-phase converter receives three phase electrical power in windings of a three phase induction motor. The motor has a rotor and induction windings with three connections in parallel in a delta wiring configuration. Two of the connectors are also connected in parallel to a two phase load, such as the electrical wiring of a residence or a two-phase electrical grid. Two phase power provided thereby has characteristics similar to electricity provide by a conventional utility grid. Switches may be controlled to optionally disconnect the load and/or the grid from the rotary converter as necessary.

In various embodiments, the induction motor rotor may be free rotating, coupled to a rotational inertia mass (i.e., fly-wheel) or mechanically connected to a mechanical load. When connected to a mechanical load, such as a swimming pool pump, air conditioning compressor, etc., a clutch may be included to allow the load to be disconnected from the rotor shaft when the mechanical output is not needed or the motor is not capable of turning the mechanical load due to low input power.

### BRIEF DESCRIPTION OF THE DRAWINGS

The accompanying drawings, which are incorporated herein and constitute part of this specification, illustrate exemplary aspects of the invention, and, together with the general description given above and the detailed description given below, serve to explain features of the invention.

FIG. 1 is a circuit diagram of an example embodiment of a rotary three-phase to two-phase converter.

FIG. 2 is a voltage vs. time graph showing the relationship between the phases of a three phase power source.

FIG. 3 is a voltage vs. time graph showing the differences in peak to peak values between two arbitrary phases of a three phase system.

FIG. 4 is a system block diagram of an implementation of an embodiment implemented within a solar power generation system.

FIG. 5 is a component block diagram of an embodiment rotary three-phase to two-phase converter with the rotor coupled to a mechanical load.

FIG. 6 is an example of a single pulse amplitude modulated current converter according to the present invention.

FIG. 7 shows a pulse amplitude modulated current converter with a transistor completing the circuit to charge inductors while reconstruction filters produce current pulses for the grid positive half phase.

FIG. 8 shows a pulse amplitude modulated current converter with current flowing through into the reconstruction filters for the grid positive half phase.

FIG. 9 shows a pulse amplitude modulated current converter with a transistor completing the circuit to charge inductors while reconstruction filters produce current pulses for the grid negative half phase.

FIG. 10 is a graph relating the timing of drive signals and current.

FIG. 11 shows the portion of current in a sine wave of current that is examined in detail in some following drawings.

FIG. 12 shows the pulses provided by a single pulse amplitude modulated current converter.

FIG. 13 shows the pulses provided by two pulse amplitude modulated current converters and their total, summed current.

FIG. 14 shows the pulses provided by eight pulse amplitude modulated current converters and their total, summed current.

FIG. 15 shows an alternative circuit for a single pulse amplitude modulated current converter.

FIG. 16 shows a circuit for a single pulse amplitude modulated current converter wherein the converter can be disabled.

FIG. 17 is an example of a single DC source providing current to a plurality of pulse amplitude modulated current converters to form a power supply to a common load.

FIG. 18 defines the basic phase relationships in a three phase electrical system.

FIG. 19 is an example of a most negative voltage phase providing current to two other phases according to the method of the present invention.

FIG. 20 is an example of a most positive voltage phase providing current to two other phases according to the method of the present invention.

FIG. 21 is an example of a three phase pulse amplitude modulated current converter according to the present invention, configured as a wye output circuit.

FIG. 22 is an example of a three phase pulse amplitude modulated current converter according to the present invention, configured as a delta output circuit.

FIG. 23 shows the current path for an exemplary conversion cycle related to the current IBA, as illustrated in FIG. 16.

FIG. 24 shows the current path for an exemplary conversion cycle related to the current IBC, as illustrated in FIG. 16.

FIG. 25 defines current and time terms as used in various equations.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments provide a three phase to two phase electrical power converter that leverages the induction characteristics of a delta wired induction motor to convert three phase power to two-phase power efficiently without the need for a separate generator (as in a typical motor generator) to power consumer electronics and appliances. Magnetic and mechanical feedbacks within the induction motor enable the output of stable two phase electrical power that may be suitable for use in a two-phase electrical grid as is typical in a residence. Using well-known motor technology and few if any electronic components, the rotary phase converter in its various embodiments provides a low-cost and highly reliable power phase converter that may be suitable for implementation in small power generating systems, such as residential solar power systems.

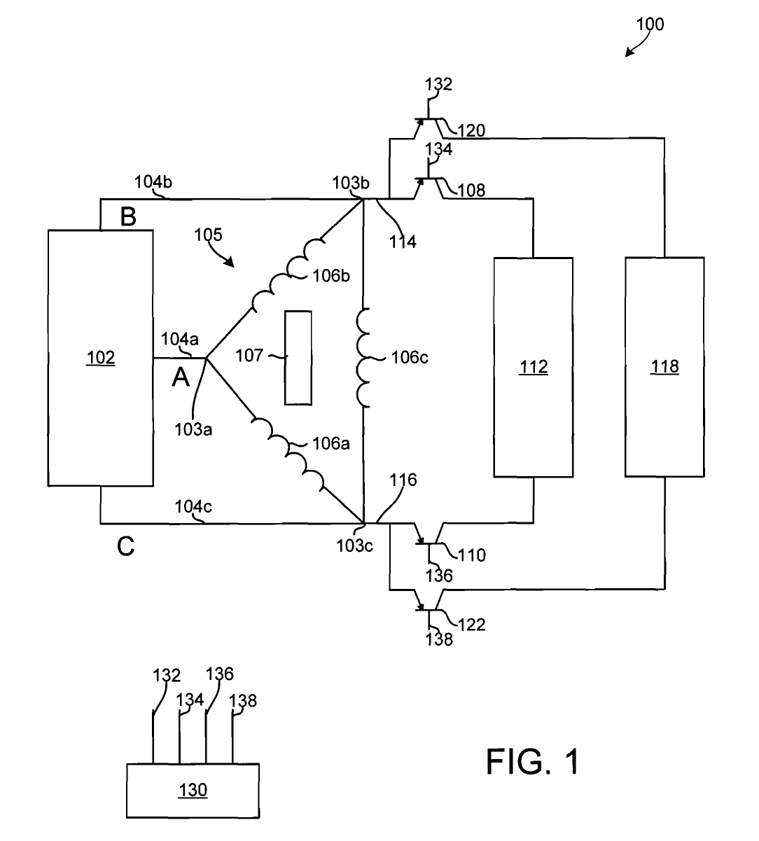

FIG. 1 illustrates an embodiment rotary three-phase to two-phase converter 100. In rotary phase converter 100, a three phase electrical power source 102 may be electrically connected to an induction motor 105. Induction motor 105 may be comprised of three windings 106a, 106b, and 106c which may be connected together in a delta configuration. Wires 104b, 104a, 104c carrying three phase current, arbitrarily denominated phases A, B and C may be coupled to the three windings 106a, 106b, 106c of the induction motor 105 at the windings nodes 103a, 103b, 103c. For example, arbitrary phase A carried by wire 104a and arbitrary phase B carried by wire 104b, may be connected to windings nodes 103a and 103b at either end of field windings 106b (i.e., field windings 106b is connected across phases A and B). Similarly, phase A 104a and phase C 104c may be connected to windings nodes 103a and 103c at either end of field windings 106a (i.e., field windings 106a may be connected across phases A and C). Phase B on wire 104b and phase C on wire 104c may be connected to windings nodes 103b and 103c at either end of field windings 106c (i.e., field windings 106c may be connected across phases B and C). In this manner, the connections of the three phase electrical source 102 to the induction motor 105 may be similar to those of a conventional induction motor.

The three electrical currents provided by the three phase electrical source 102 may nominally be 120 degrees out of phase with respect to each other, as is typical in U.S. three-phase electrical power systems. In order to obtain two-phase current, electrical leads 114 and 116 may be coupled to two of the induction motor winding nodes, such as 103b and 103c as shown in FIG. 1.

The rotor 107 of the induction motor 105 may be an electromagnet. Magnetic fields generated by the three windings 106a, 106b, 106c may cause the rotor 107 to rotate at a speed corresponding to the frequency of the three phase power, for example 50 Hz or 60 Hz, depending upon the country standard. The rotor 107 may magnetically interact with the magnetic fields generated by the field windings 106a, 106b, and 106c. The power in the three fields may be equal during any switching cycle, thereby providing the power of the three phases A, B, C into the two output phases.

Due to the magnetic and electrical interactions of the windings of the induction motor 105 with the rotor 107, particularly in view of the rotational inertia of the rotor 107, the electrical current obtained from the connection wires 114, 116 may be two-phase (i.e., the phase of the current on wires 114 and 116 may be 180° out of phase). This two-phase current may be applied to a two-phase load 112, such as the electrical wiring of a residence, business or conventional two-phase electrical equipment. No further conditioning or control of the electrical output may be required in order to provide usable two-phase current.

In an embodiment illustrated in FIG. 1, the two-phase current may also be output to a two-phase grid connection 118. Thus, the two-phase current obtained from the rotary phase converter 100 may be used to supply two-phase current to a residential load 112 and a two-phase power grid 118, such as a two-phase power grid 118 servicing neighboring residences. In an embodiment, switches 108, 110, 120, 122 may be connected to the two-phase current output wires 114, 116, and configured so that the two-phase grid 118 and/or residential two-phase load 112 may be selectively coupled to or disconnected from the rotary phase converter 100. These switches 108, 110, 120, 122 are shown in FIG. 1 as transistors, but further embodiments may include various diodes, mechanical switches, relays or other devices for diverting current. Switches 108, 110, 120, and 122 may be controlled by a programmable controller 130 as described more fully below.

Once the rotor 107 is rotating, the induction motor 105 may be driven by the three-phase electrical power, and two-phase power may be obtained from any of the wiring nodes 103b, 103c. Three-phase induction motors may require some mechanism for initiating rotation of the rotor 107 upon the initial power up the system. This is because the rotor 107 may not be separately magnetized and rather has magnetic fields induced by the magnetic fields generated in the stator windings. Any of a variety of mechanisms may be used to initiate the rotation of the rotor 107, such as conventional induction motor mechanisms for starting a motor. In an embodiment, a controller within the three-phase electrical source 102 may be configured to apply power to the three-phase supply wires 104a, 104b, and 104c in a controlled manner that may cause the rotor to begin rotating before three phase power is applied. In another embodiment, an external motor, such as a two-phase motor may be coupled to a shaft connected to the rotor 107 and used to initiate the rotor 107 rotations. In an another embodiment, mechanisms may be used to start rotation, including a hand crank. Once the rotor 107 is rotating under three phase power applied to the induction motor 105, no further mechanisms may be needed to maintain rotation other than the application of the three-phase current.

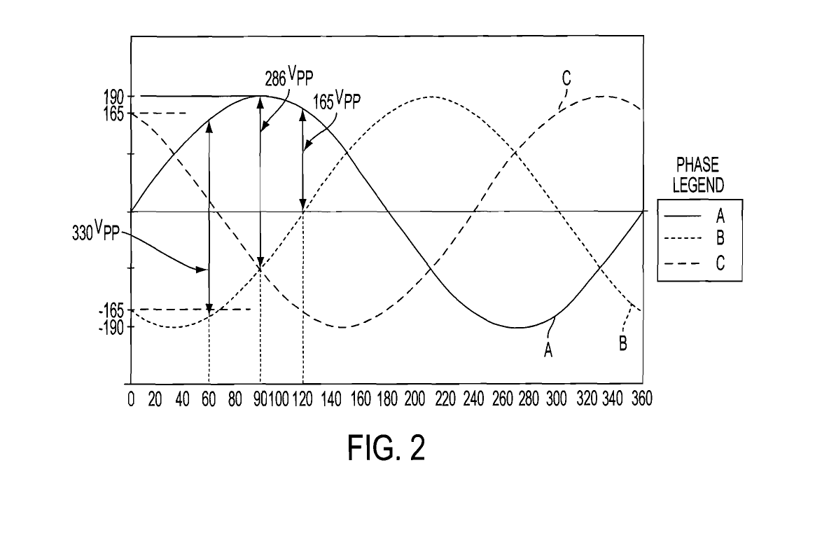

Electrical characteristics of the three-phase windings of the induction motor 105 are illustrated in FIG. 2, which shows one power cycle. For a standard United States installation, 110 volts root mean square (RMS) alternating current may be provided by each of the three phases. In such three phase power, each phase attains approximately 190 volts at its maximum relative to a common point. Since two-phase power is obtained from two of the winding nodes 103b, 103c the output power represents the voltage from phase to phase (Vpp) between any two phases. FIG. 2 shows how this Vpp voltage varies over time between two phases (i.e. A and phase C). Values extracted from FIG. 2 at various phase points are listed in Table 1:

TABLE 1
Voltage Values At Various Phase Points

| | 0 Deg | 60 Deg | 120 Deg | 180 Deg |
|---|---|---|---|---|
| Phase A, Vpp | 0 | 15 | 165 | 0 |
| Phase B, Vpp | 165 | 0 | −165 | −165 |
| Phase C, Vpp | −165 | −165 | 0 | 165 |
| (Va − Vb) | −165 | 165 | 330 | 165 |

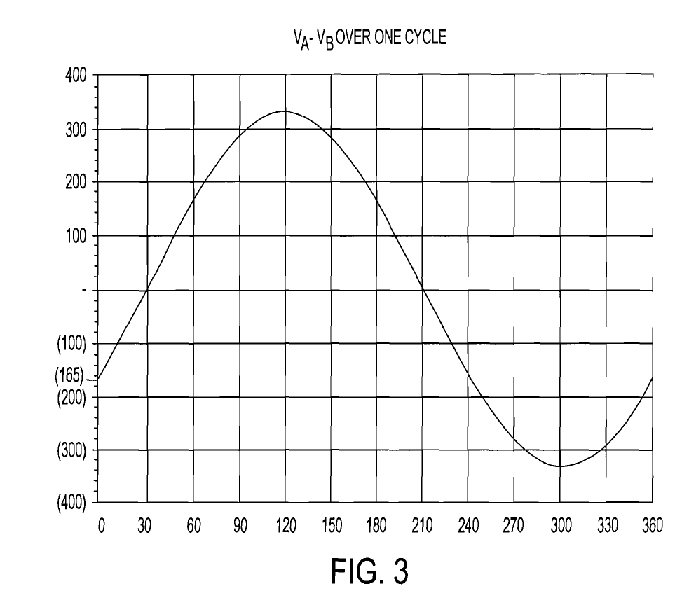

The last line in Table 1 shows the values for the difference in voltage between phase A and phase B. This Vpp is shown graphically in FIG. 3. As illustrated in FIG. 3, the resulting output power has a smooth two-phase waveform. Thus, the power that may be delivered to a residence as two phase power from a three phase distribution source corresponds to FIG. 3 as two 120 volt RMS signals 180 degrees out of phase with each other.

As previously discussed with reference to FIG. 1, two switches 120 and 122 may connect the two phase output 114, 116 to a utility grid 118. Two other switches 108 and 110 may connect the two phase output 114, 116 to a two phase load 112, such as a residence, factory, building, or conventional two-phase machinery. During periods of operation when the power system 102 may be unable to provide enough power to bring the voltage output on the lines 114, 116 up to that required by the grid 118 (e.g., during sunrise or sunset or heavy cloud cover for a solar power generator), the grid connection switches 120 and 122 may be opened. Likewise, the two-phase load 112 isolation switches 108, 110 may be opened or closed by the programmable controller 130, depending upon the power output of the three phase power source 102 and/or the demand of the two-phase load 112. The switches 108, 110, 120, 122 may be controlled by the programmable controller 130 applying control signals, such as gate voltages in the case where the switches 108, 110, 120, 122 are transistors or relays. As illustrated in FIG. 1, four control signals 132, 134, 136, and 138 from the controller 130 may be coupled with switches 108, 110, 120, and 122 respectively. In an embodiment, the programmable controller 130 may be part of the three phase electrical source 102. In another embodiment, the programmable controller may be part of the rotary phase converter 100. In yet another embodiment, the programmable controller may be a stand alone unit which monitors the output power on lines 114 and 116 and reacts according.

In an embodiment, the rotor 107 may be configured to rotate without applying any mechanical load to other systems, serving only to cause the proper phase relationship of current across the output nodes 103b, 103c. In another embodiment, the rotor 107 may be coupled to a flywheel in order to provide more rotational inertia, which may assist in ensuring that the output current remains in phase even when a sudden increase in electrical load (e.g., a large motor starting) appears on the two-phase load 112.

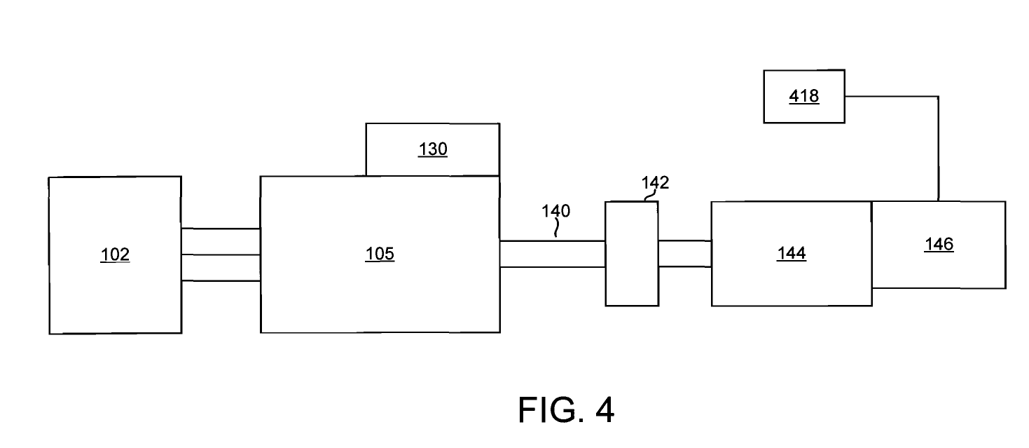

In a further embodiment illustrated in FIG. 4, the rotor 107 of the induction motor 105 may be coupled to a shaft 140 which may be connected to a mechanical load 144. Even while output electrical power on wires 114, 116 is drawn primarily from the windings 106a, 106b, 106c, current through the windings may also be used to carry a mechanical load coupled to an output shaft 140. Due to the fact that no further electrical or mechanical conversion may be required, such mechanical output may be achieved at much greater efficiency than would be possible if the two-phase output current were used to drive an electrical motor to provide the same mechanical output. Thus, in an implementation where there may be a constant need for a mechanical output during periods when the rotary phase converter is operating, driving such mechanical loads with the shaft 140 may provide a high efficiency implementation. For example, in a solar installation in which the rotary phase converter may operate during sunlight hours, there may also be a need to drive an air-conditioning compressor or other rotary machinery, such as a swimming pool pump. A clutch 142 may be coupled to the shaft 140 to enable the mechanical load 144 to be disengaged from the rotary phase converter, such as when the rotary load is carried by a motor 146 driven by utility power from a grid 418, such as may be required at night in a solar power installation. When adequate power is provided by the three phase electrical source 102 the clutch 142 may be closed and the system may power a mechanical load 144 at a better efficiency than would be possible by providing the two phase power on lines 114, 116 to a conventional two-phase motor.

In some embodiments, the three phase electrical source 102 may be a solar panel generation system configured to output three-phase currents, such as to a utility grid. In some embodiments, the three phase electrical source 102 comprises solar panels connected to a three phase power inverter. Other three phase sources may also be coupled to the rotary phase converter of the various embodiments.

In further embodiments, the three phase electrical source 102 may include a solar panel installation and a pulse amplitude modulated current converter. The three phase electrical source 102 comprising a solar panel installation and a pulse amplitude modulated current converter may be coupled to the rotary phase converter. Pulse amplitude modulated current converters are discussed below.

A DC to pulse amplitude modulated (“PAM”) current converter, denominated a “PAMCC” may be connected to an individual solar panel (“PV”). A solar panel typically may be comprised of a plurality, commonly seventy-two, individual solar cells connected in series, wherein each cell may provide approximately 0.5 volts at some current, the current being a function of the intensity of light flux impinging upon the panel. The PAMCC may receive direct current (“DC”) from a PV and may provide pulse amplitude modulated current at its output. The pulse amplitude modulated current pulses may typically be discontinuous or close to discontinuous with each pulse going from near zero current to the modulated current and returning to near zero between each pulse. The pulses may be produced at a high frequency relative to the signal modulated on a sequence of pulses. The signal modulated onto a sequence of pulses may represent portions of a lower frequency sine wave (e.g., a 60 Hz AC current waveform) or other lower frequency waveform, including DC.

When the PAMCC's output is connected in parallel with the outputs of similar PAMCCs an array of PAMCCs may be formed, wherein the output pulses of the PAMCCs are out of phase with respect to each other. An array of PAMCCs constructed in accordance with the present invention may form a distributed multiphase inverter whose combined output may be the demodulated sum of the current pulse amplitude modulated by each PAMCC. If the signal modulated onto the series of discontinuous or near discontinuous pulses produced by each PAMCC was an AC current sine wave, then a demodulated, continuous AC current waveform may be produced by the array of PAMCCs. This AC current waveform may be suitable for use by both the “load,” such as a home powered or partially powered by the system, and for connection to a two-phase power grid. For example, in some embodiments an array of a plurality of PV-plus-PAMCC modules may be connected together to nominally provide split-phase, Edison system 60 cps 240 volt AC to a home.

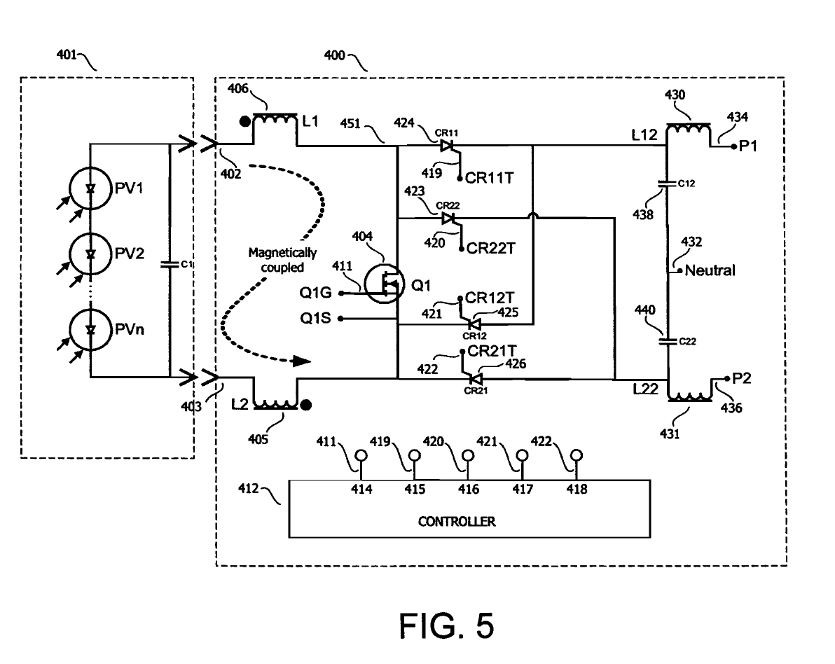

Before discussing an array comprising a plurality of PV-plus-PAMCC modules, an individual PAMCC is described. For example, referring to FIG. 5, a PV panel is electronically represented by the diodes and capacitor shown as reference numeral 401. Collectively, the components comprising a PAMCC (or sometimes “micro inverter”) are referred to as simply “the PAMCC 400.” Current may be provided by the PV 401 to a positive input terminal 402 and a negative input terminal 403. The positive input terminal 402 may be connected in series with a coil L1 406. The negative input terminal 403 may be connected in series with a coil L2 405. In one embodiment coils L1 406 and L2 405 may form a one-to-one transformer with two input and two output terminals. Such an embodiment may provide better current matching through the two current paths. In such an embodiment the coils L1 406 and L2 405 may form a single transformer. A switch Q1 404, for example an NMOS FET, may be connected across the load side of the transformer formed by coils L1 406 and L2 405, with the source of Q1 404 connected in parallel to the negative terminal of the transformer formed by coils L1 406 and L2 405 negative output. Though discussed in relation to an example NMOS FET, switch Q1 404 may be any known type of technology capable of performing a switching function, including relays, transistors, bi-polar transistors, insulated-gate bipolar transistors (IGBTs), silicon carbide relays, nitride transistors, thyristors, MOSFETs, series connected MOSFETs, thyristor emulators, and diodes in series with IGBTs to name just a few. The negative sides of the PV 401 and of the PAMCC 400 are floating; that is, they are not grounded. A controller 412 may have an output terminal 414 which provides a signal to the control gate (Q1 G) of Q1 404 on a line 411. In some embodiments the controller 412 is a microprocessor with additional logic and is operated by a program. The controller 412 is discussed in more detail below.

The controller 412 may comprise a plurality of output terminals, each operated independently. Controller 412 output terminals 415, 416, 417, and 418 may be connected to the control terminals of the four SCRs (CR 11 424; CR 22 423; CR 12 425; and CR 21 426, respectively) by four lines 419, 420, 421, and 422 respectively (inner-connections not shown). Each line, therefore each SCR, may be independently controlled by control signals from the controller 412. The anode terminals of CR 11 424 and CR 22 423 may be connected in parallel to the positive output terminal of the transformer created by coil L1 406 and L2 405. The cathode terminals of SCRs CR 12 425 and CR 21 426 are connected in parallel to the negative output terminal of the transformer created by coil L1 406 and L2 405. The cathode terminal of SCR CR 11 424 and the anode terminal of SCR CR 12 425 are connected in parallel to a coil L12 430. The cathode terminal of SCR CR 22 423 and the anode terminal of SCR CR 21 426 are connected in parallel to a coil L22 431. A terminal 434 from coil L12 430 may be arbitrarily designated as providing a “phase 1” (P1) output and a terminal 436 from coil L22 431 may be arbitrarily designated as providing a “phase 2” (P2) output. In some embodiments the coils L12 430 and L22 431 may be embodied in a one-to-one transformer. In the embodiment exemplified in FIG. 5 coils L12 430 and L22 136 are separate coils. A capacitor C12 438 may be connected across the input side of coil L12 430 and a neutral output terminal 432. Another capacitor C 22 440 may be connected across the input side of coil L22 431 and the neutral output terminal 432. In another embodiment there may be no neutral output terminal 432 and there may be a single capacitor across the input terminals of coil L12 430 and L22 431; and the voltage rating of the capacitor may be at least twice that of capacitors C22 440 and C12 438.

Operation of the system may be implemented by control signals on lines 411 and 419 through 422. In particular the control signal Q1G on line 411 and signals CR11T on line 419; CR22T on line 420; CR12T on line 421; and CR21T on line 422 connect and disconnect the current provided by PV 401 in a sequence within the PAMCC 400 with a high-frequency period, for example 30 KHz, which may provide a PCM signal which is modulated by a slower, 60 cycle pattern, thereby providing an output whose amplitude may be a PAM signal approximating a sine wave.

Referring to FIG. 5, the initial conditions are as follows: Q1 404, CR11 424, CR22 423, CR12 425 and CR21 426 de-energized; coils L1 406, L2 405, L12 430 and L22 431 empty of current; and photovoltaic cells PV 1, PV2, and PVn dark. In this condition the grid AC voltage may be applied between P1 434 and P2 436 and experiences a path through L12 430, C12 438, C22 440 and L22 431. The resonant frequency selected for a reconstruction filter comprising L12 430 and C12 438 may typically be chosen to be about one half the switching frequency of Q1 404. The resonant frequency of a reconstruction filter comprising L22 431 and C22 440 may be chosen to be the same as the reconstruction filter of L12 430 and C12 438. In one embodiment the transistor Q1 404 may be selected for a specified switching frequency of approximately 30 kHz and the resonant frequency of the reconstruction filters may then be designed for 15 kHz. With the grid AC voltage typically being 60 Hz, an unimportant amount of capacitive reactive load is presented to the grid.

Circuit operation begins with the solar panel 401 being exposed to sufficient light to produce significant current. The presence of the current may be observed as an increase in voltage across Q1 404. At this point Q1 404 is initially turned on by applying a signal from controller 412 on line 411 between Q1G and Q1S. The interface between the controller 412 and the transistor Q1 404 may be optically isolated, transformer coupled, or the controller 412 may be connected to Q1S. In this state L1 406 and L2 405 may begin to charge with current. When the voltage across PV 401 falls to a predetermined value, the time to charge the coils may be noted in order to calculate the current and standard operation may begin with the next grid zero crossing. In one embodiment this may be when the voltage at P1 crosses above P2 while P1 is going positive and P2 is going negative. At this point signals CR11T 419 and CR21T 421 may be asserted such that CR11 424 and CR21 426 may conduct when current is applied to them.

CASE 1: PWM modulation for positive half wave of the grid.

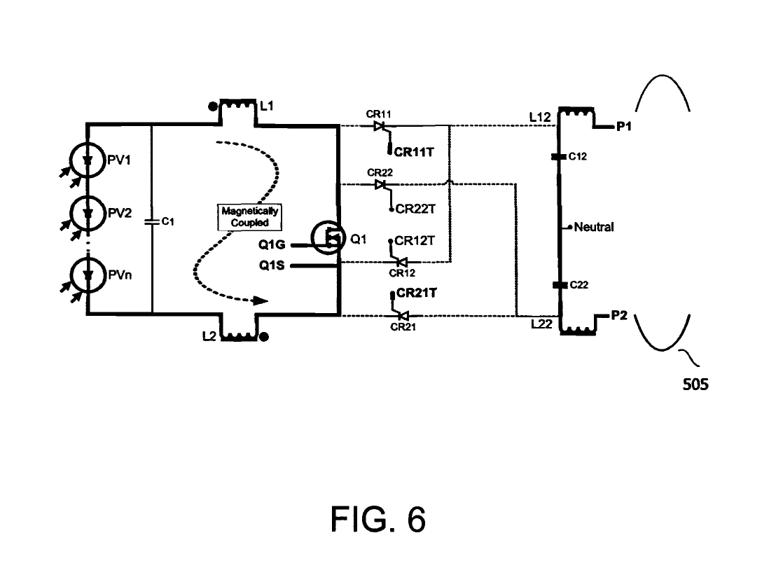

FIG. 6 through FIG. 9 will be referred to in describing the operation of PAMCC 400. Note that the components correspond to those of FIG. 5, but the reference numbers have been left off so as not to obscure the description. However, the following description refers to the reference numbers provided by FIG. 5.

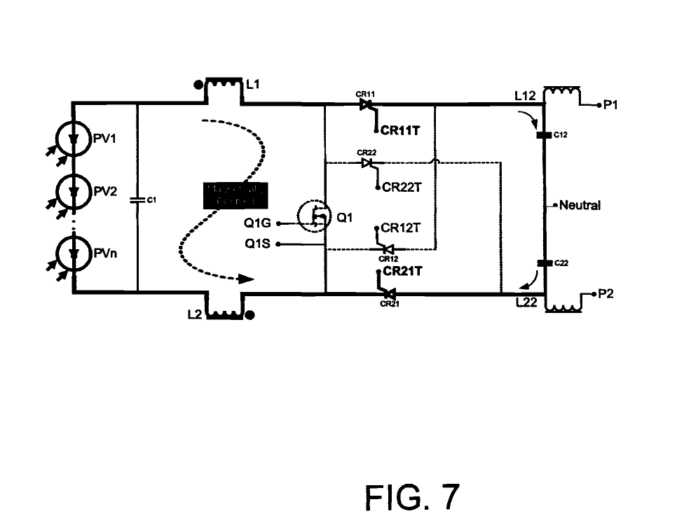

Referring to FIG. 6, with L1 406 and L2 405 charged, Q1 404 may be turned off for a pulse width modulated time. After the off time has expired, Q1 404 may be turned on until the end of the current switching cycle. As illustrated in FIG. 7, during the time that Q1 404 is off, current previously stored in L1 406 and L2 405, together with the current flowing in PV 401, may be applied to the input terminals of CR11 424 and CR21 426, which remain enabled as a result of the signals CR11T 419 and CR21T 421 for the entire positive half cycle of the grid. The positive half cycle of the grid may be defined as the condition wherein the voltage at output terminal P1 434 is greater than the voltage at output terminal P2 436. The charge in the current pulse delivered through the SCR CR11 424 may be initially stored on capacitor C12 438, creating a voltage more positive on the near end of coil L12 430 relative to the end of coil L12 430 which is connected to the output terminal P1 434. The charge in the current pulse delivered through SCR CR21 426 may initially be stored on capacitor C22 440, creating a voltage more negative on the near end of coil L22 431 relative to the end of coil L22 431 which is connected to the output terminal P2 436. This may be the initial condition for both the reconstruction filter comprising L12 430 and C12 438 and the reconstruction filter comprising L22 431 and C22 440. At this point the reconstruction filters may transform the pulse width modulated current pulse delivered to them to a pulse amplitude modulated (PAM) half sine wave of current 505 delivered to the grid as shown in FIG. 6.

The resonant frequency for the reconstruction filters may be chosen to be about one half the switching frequency of Q1 404 so that one half of a sine wave of current will be provided to P1 434 and P2 436 for each pulse width modulated current pulse delivered to them. Since the resonate frequency of each reconstruction filter may be independent of the pulse width of current applied to it, and the charge in the instant current pulse applied to the reconstruction filter may be equal to the charge in the half sine wave of current delivered out of the reconstruction filter to the grid. Changes in the pulse width of input current may be reflected as changes in the amplitude of the output of the reconstruction filters. As the current in the inductors in the reconstruction filters returns to zero, the next pulse of current may be delivered to the capacitors of the reconstruction filters because the frequency of the reconstruction filters may be one half the rate at which pulse width modulated current pulses are produced by Q1 404.

The off time of Q1 404 may be modulated such that the width of current pulses produced is in the shape of the grid sine wave. The reconstruction filters transform this sequence of pulse width modulated current pulses into a sequence of pulse amplitude modulated current pulses whose amplitude follows corresponding points of the shape of the grid sine wave.

So long as the grid half cycle remains positive at the terminal P1 434 relative to the output of terminal P2 436, further current pulses are produced by repeating the process described hereinbefore, beginning at “CASE 1: PWM modulation for positive half wave of the grid”.

The negative zero crossing of the grid voltage is defined as the condition wherein the voltage at terminal P1 434 is equal to the voltage at terminal P2 436 after P1 434 has been more positive than P2 436. Prior to the negative zero crossing, Q1 404 may be turned on, thereby removing current from CR11 424 and CR21 426. At this point the signals CR11T 419 and CR21T 421 may be de-asserted, preventing SCRs CR11 424 and CR21 426 from conducting current during the grid negative half cycle. After the negative zero crossing, with the voltage of terminal P1 434 more negative than the voltage of terminal P2 436, the signals CR22T 420 and CR12T 421 may be asserted, enabling CR22 423 and CR12 425 to conduct when current is applied to them.

CASE 2: PWM modulation for the negative half wave grid

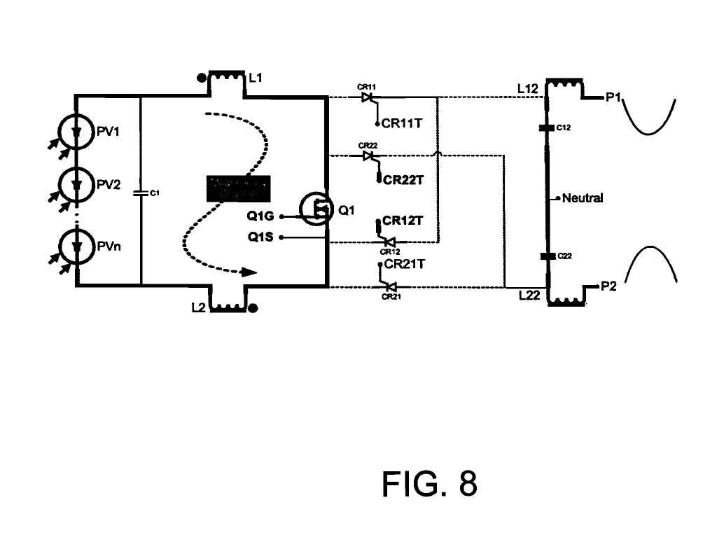

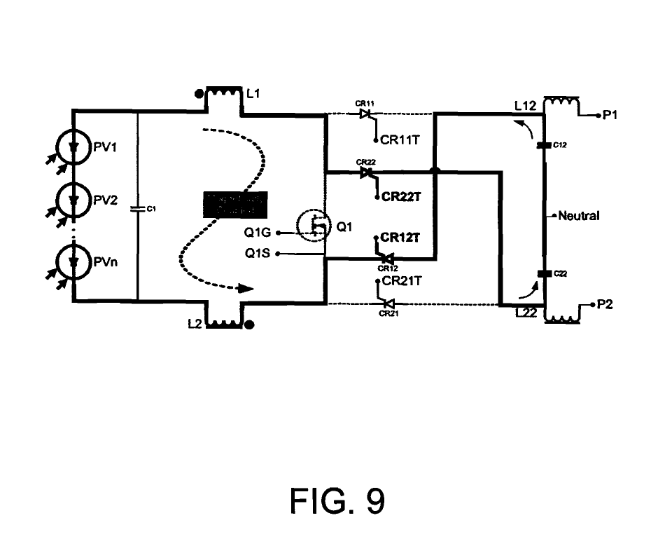

Referring to FIG. 7, with L1 406 and L2 405 charged Q1 404 may be turned off for a pulse width modulated time. As illustrated in FIG. 8, after the off time has expired, Q1 404 may be turned on until the end of the instant current switching cycle. As illustrated in FIG. 9, during the time that Q1 404 is off, current previously stored in L1 406 and L2 405 together with the current flowing in PV 401 may be applied to the input terminals of CR12 425 and CR22 423 which remain enabled by signals CR22T 420 and CR12T 421 for the entire negative half cycle of the grid. The negative half cycle of the grid is defined as the condition wherein the voltage at terminal P1 434 is less than the voltage at terminal P2 436. The charge in the current pulse delivered through the SCR CR22 423 may initially be stored on capacitor C22 440, creating a voltage more positive on the near end of coil L22 431 relative to the end connected to terminal P2 436. The charge in the current pulse delivered through CR12 425 may initially be stored on coil C12 438, creating a voltage more positive on the near end of coil L12 430 relative to the end connected to terminal P1 434. This may be the initial condition for both the reconstruction filter comprising L12 430 and C12 438 and the reconstruction filter comprising L22 431 and C 22 440. At this point the reconstruction filters will transform the pulse width modulated current pulse delivered to them to a pulse amplitude modulated half sine wave of current delivered to the grid as shown in FIG. 8.

The reconstruction filters for Case 2 may be the same components as described in association with Case 1; their design and operation are not repeated here.

The off time of Q1 404 may be modulated such that the width of current pulses produced is in the shape of the grid sine wave. The reconstruction filters may transform this sequence of pulse width modulated current pulses into a sequence of pulse amplitude modulated current pulses whose amplitude follow corresponding points of the shape of the grid sine wave.

So long as the grid half cycle remains negative, with the voltage of terminal P1 434 more negative than the voltage of terminal P2 436, further current pulses may be produced by repeating the process described hereinbefore, beginning at “CASE 2: PWM modulation for negative half wave of grid.”

The positive zero crossing of the grid voltage is defined as the condition wherein the voltage at terminal P1 434 is equal to P2 436 after the voltage at terminal P1 434 has been more negative than the voltage of terminal P2 436. Prior to the positive zero crossing, Q1 404 may be turned on, removing current from SCRs CR12 425 and CR22 423. At this point the signals CR12T 421 and CR22T 420 may be de-asserted, preventing SCRs CR12 425 and CR22 423 from conducting current during the grid positive half cycle. After the positive zero crossing with P1 434 being more positive than P2 436, signals CR11T 419 and CR21T 421 may be asserted, enabling SCRs CR11 424 and CR21 426 to conduct when current is applied to them.

With the grid again positive, the process may again return to the process described above beginning with the section labeled CASE 1: PWM modulation for positive half wave of the grid.

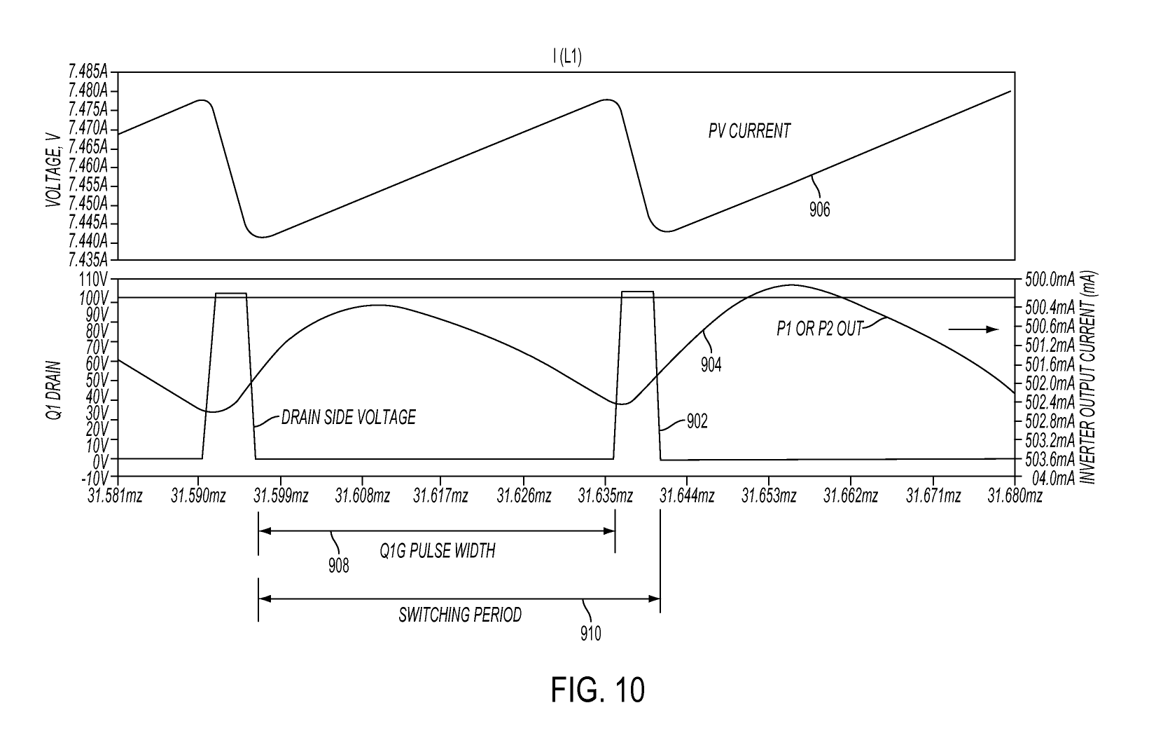

FIG. 10 is a signal diagram of the results of the conversion of a pulse width modulated pulse, translated into a pulse amplitude modulated (PAM) current pulse by a reconstruction filter, such as those discussed above (L12 430 and C12 438 and/or L22 431 and C22 440). The short duration roughly rectangular voltage pulses 902 are the voltage on the drain side 451 of Q1 404. The pulse width labeled 908 approximates the pulse width of the signal Q1G on line 411 and the period 910 is the switching period of the PAMCC 400. This voltage drives the coil L1 406, L2 405, and PV 401 currents through a SCR CR11 424 or CR12 425 (depending upon the instant status of the control signals from controller 412, as previously described) into the input of one of the reconstruction filters. The rounded half wave rectified sine wave 904 may be the output of the reconstruction filter. As the pulse width 908 of the input pulse increases, the amplitude of the output wave form 904 may increase. The triangular wave form 906 at the top of the graph plots the variation of current through PV 401 during the common window of time. Trace 906 shows the effect of the coils L1 406 and L2 405 in maintaining a relatively constant PV 401 current, independent of the relatively large pulse width modulated current pulses provided to the reconstruction filters.

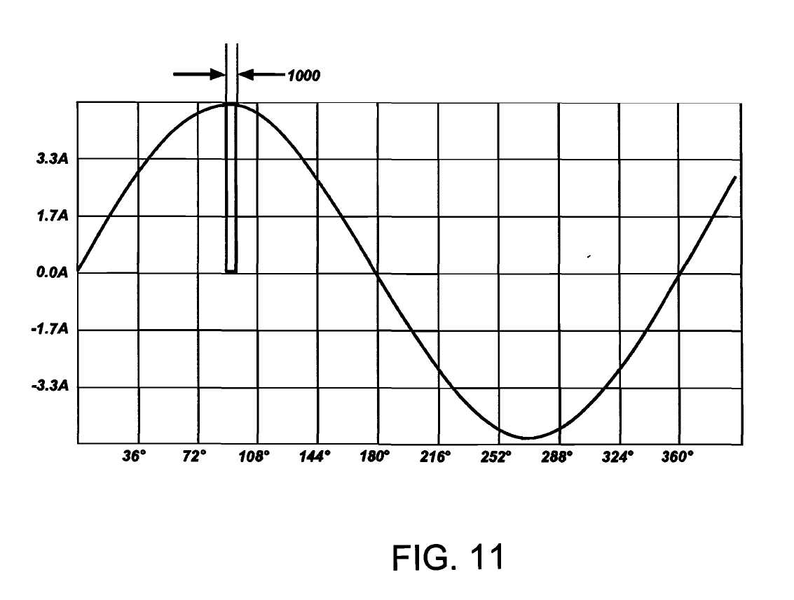

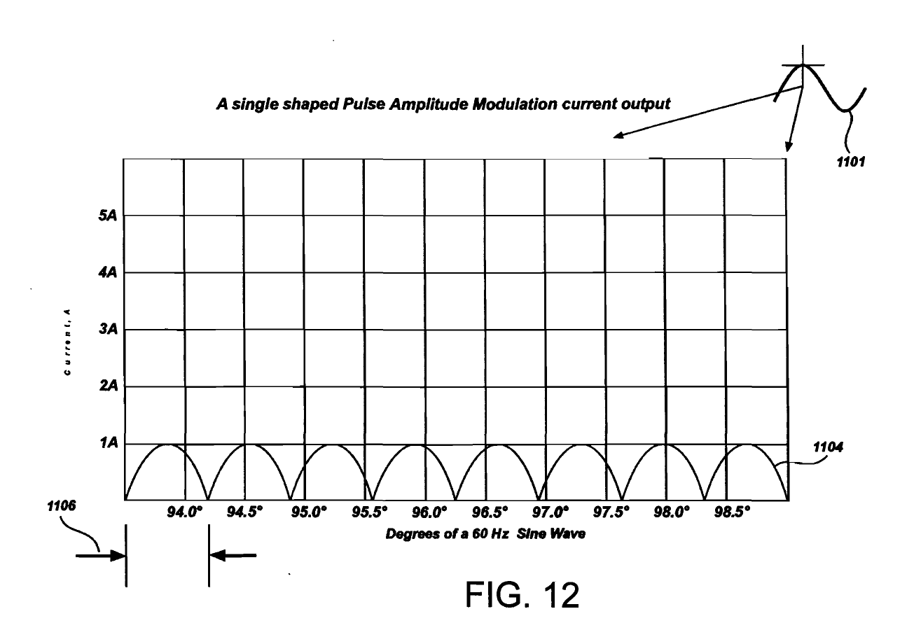

FIG. 11 illustrates the narrow time slice of a grid sine wave cycle to be illustrated in FIGS. 12, 13 and 14.

FIG. 12 illustrates the pulse amplitude modulated output current of a single PAMCC 400. Note that the amplitude shown is for a small portion of time near the positive peak of the grid voltage as indicated on the cycle example 1101. The individual pulses 1104 have a period 1106 equal to the period of the switching frequency, for example ( 1/30 KHz).

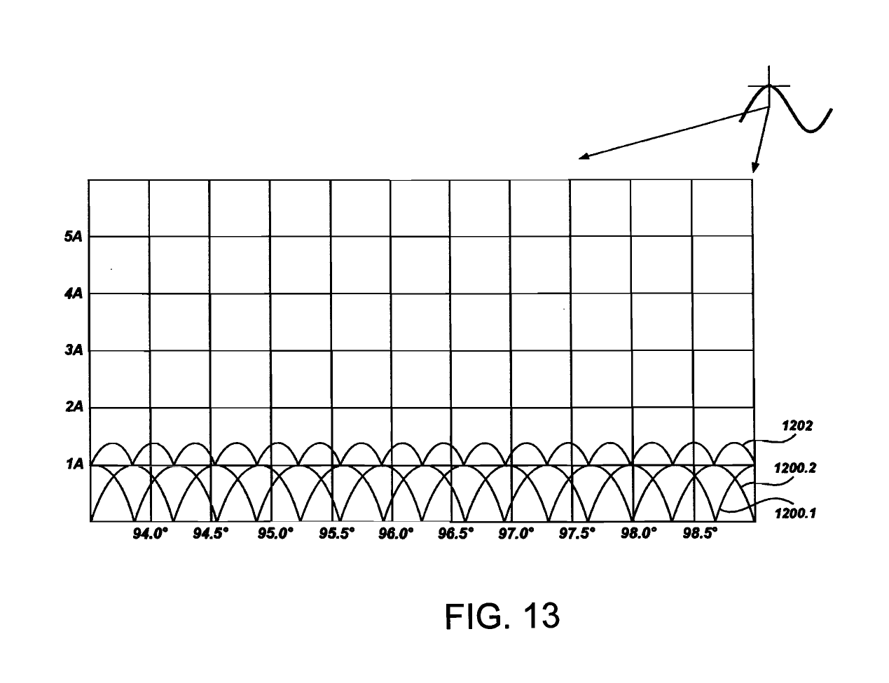

In FIG. 13, two individual currents (1200. 1 and 1200. 2) of two PAMCCs (each in accordance with the PAMCC 400) are phased apart one half of the period of the switching frequency. The trace 1202 above is the sum of the two PAMCC output currents 1200.1 and 1200.2. Note that the summed current 1202 has a much smaller ripple than the ripple of a single PAMCC (see FIG. 12) and has twice the ripple frequency as of the ripple frequency of a single inverter. The summed current 1202 does not return to zero.

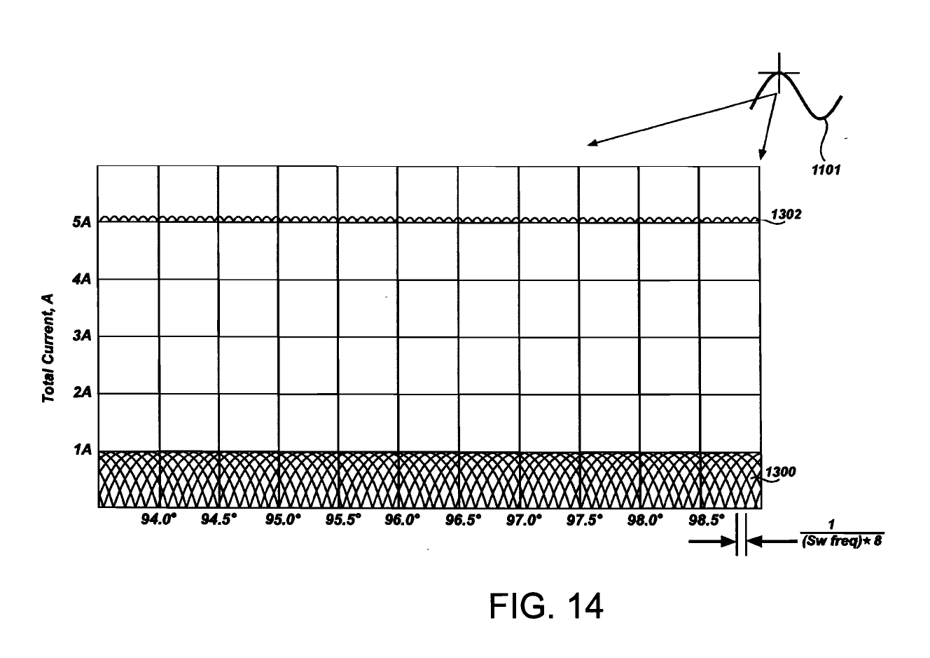

Following on the summation of the currents of two PAMCC 400 outputs, FIG. 14 shows the individual output currents of eight PAMCCs (the line 1300 is representative; each waveform is not numbered), each phased evenly across the period of the switching frequency. For example, for a system using a 30 KHz switching frequency, the period is 33.3 microseconds and each phase is delayed by (33.3/8), or 4.167 microseconds, relative to the previous output current waveform. Any number of PAMCCs 400 may be so summed. As the number summed increases they are each phase delayed by a smaller number (1/(switching frequency)*n) where “n” is the number of PAMCCs summed. Note that the summed current shown in FIG. 14 has only a fraction of the ripple current of an individual PAMCC (FIG. 13) and has eight times the ripple frequency of that of an individual PAMCC. If each PAMCC 400 is producing a point on a grid sine wave with its sequence of PAM current pulses, phasing and summing a set of PAMCCs, forming an array of converters, will effectively demodulate a grid sine wave of current with very high accuracy and very low noise (ripple). Any number of array converters may be phased and summed in this way. As the number of PAMCCs is increased, the ripple amplitude decreases and the ripple frequency increases. In one embodiment two or more of the plurality of PAMCC 400 individual output currents are in phase with each other. In some embodiments the switching frequency is selected so as to be unrelated to the grid frequency, for example 60 Hz in the United States, the ripple will not represent harmonic distortion. Signals modulated onto the PAMCC output are arbitrary. In some embodiments multiple signals are modulated onto the PAMCC output, wherein one of such signals may, for example, provide for communication between an arbitrary two or more PAMCC modules. The PAMCC modulation is sometimes used to correct for distortion in the grid signal.

One of several ways to choose the phasing of the arrayed PAMCCs 400 is for each PAMCC 400 to be pre-assigned a timing slot number, with the first slot being scheduled following a zero crossing and each PAMCC 400 firing its PAM signal in the predetermined (i.e., assigned) sequence.

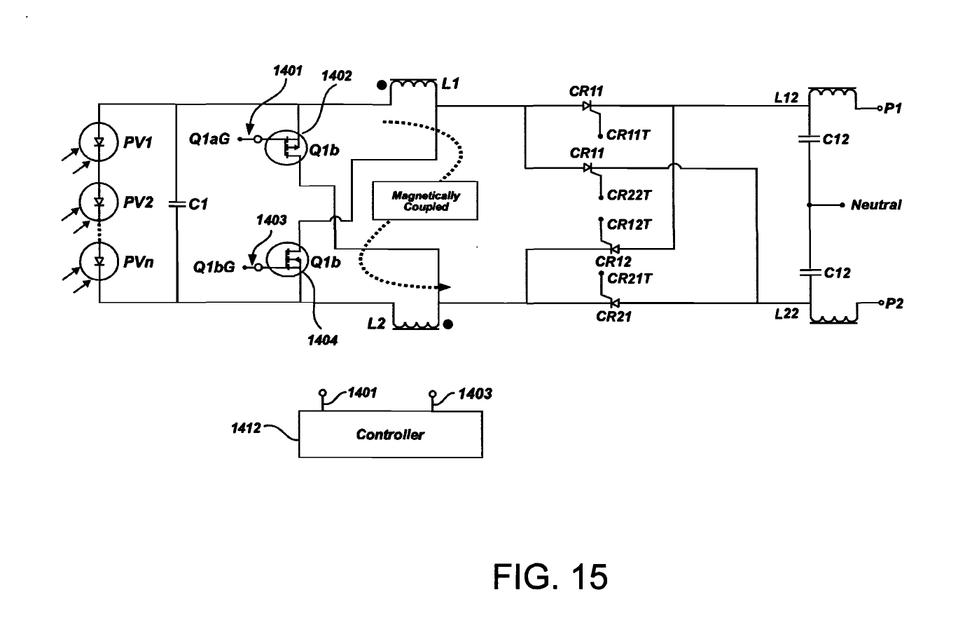

In an alternative embodiment, exemplified in FIG. 15, a second transistor is added, wherein Q1A 1402 and Q1B 1404 replace the single transistor Q1 404 as was shown and described in the circuit of FIG. 5. Though discussed in relation to example transistors, switches Q1A 1402 and Q1B 1404 may be any known type of technology capable of performing a switching function, including relays, bi-polar transistors, insulated-gate bipolar transistors (IGBTs), silicon carbide relays, nitride transistors, thyristors, NMOS FETs, MOSFETs, series connected MOSFETs, thyristor emulators, and diodes in series with IGBTs to name just a few. Using the two transistors Q1A 1402 and Q1B 1404 may provide some potential advantages, including reducing the voltage across each transistor, allowing a more relaxed Rds_on (the “on” resistance) requirement for each transistor compared to the Rds_on requirement of Q1 404, and allowing each transistor to be driven with respect to the relatively low voltage and stable anode and cathode ends of PV 401. In this configuration, Q1A 1402 and Q1B 1404 are both turned on and off at the same times as with Q1 404 in the previous discussion. All other aspects of the circuit operation remain the same. Q1A 1402 and Q1B 1404 may be of different transistor types, so separate signals to their control gates may be provided by the controller 1412. Controller 1412 is otherwise the same as controller 412 of FIG. 5, with the addition of output terminals connected to the control gates of Q1A 1402 and Q1B 1404 via lines 1401 and 1403 respectively.

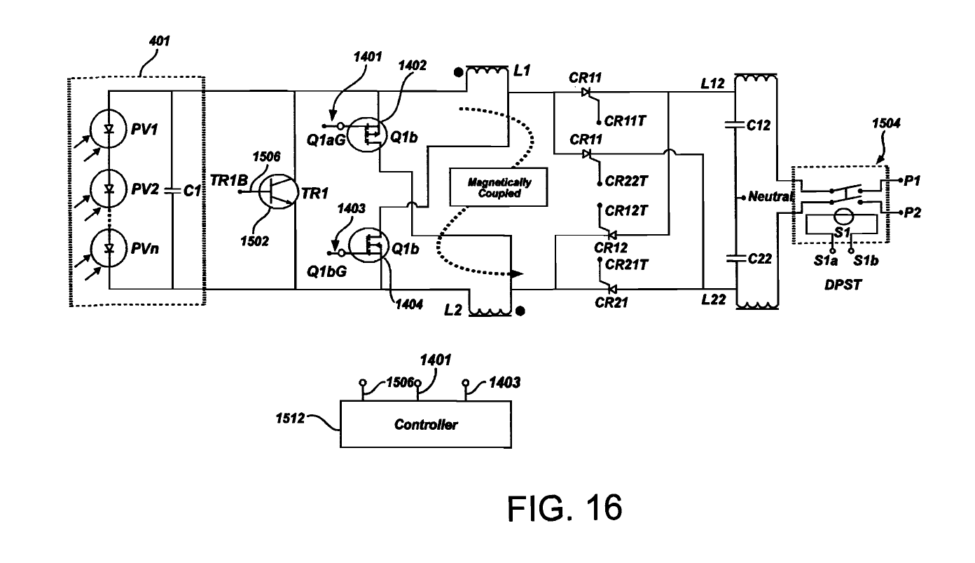

In some embodiments the system may be shut down for safety, maintenance, or other purposes. One example of a shut-down method is shown in FIG. 16. A transistor TR1 1502 and a relay S1 1504 may be added as shown. Note that this example includes the two transistors Q1A 1402 and Q1B 1404; however, the same shut-down provision may be added to the circuit of FIG. 5, wherein the two transistors Q1A and Q1B are replaced by the single transistor Q1 404. Transistor TR1 1502 and relay S1 1504 provide for the safe shutdown of PAMCC while connected to PV 401, which is illuminated and producing power. The shutdown process is initiated by providing a signal TR1 B from controller 1512 on a line 1506, the line 1506 connected to the control gate of the transistor 1502. When transistor TR1 1502 turns on, TR1 1502 creates a short path for current produced by PV 401, which results in the voltage across PV 401 to be reduced to a small level. At this point, Q1A 1402 and Q1B 1404 may be energized to allow the currents in the coils L1 406 and L2 405 to fall to a low level. After the coils L1 406 and L2 405 are discharged, relay S1 1504 may be opened. With the path to the grid now open, Q1A 1402 and Q1B 1404 may be turned off, followed by turning off transistor TR1 1502. In this configuration, no further power may be produced.

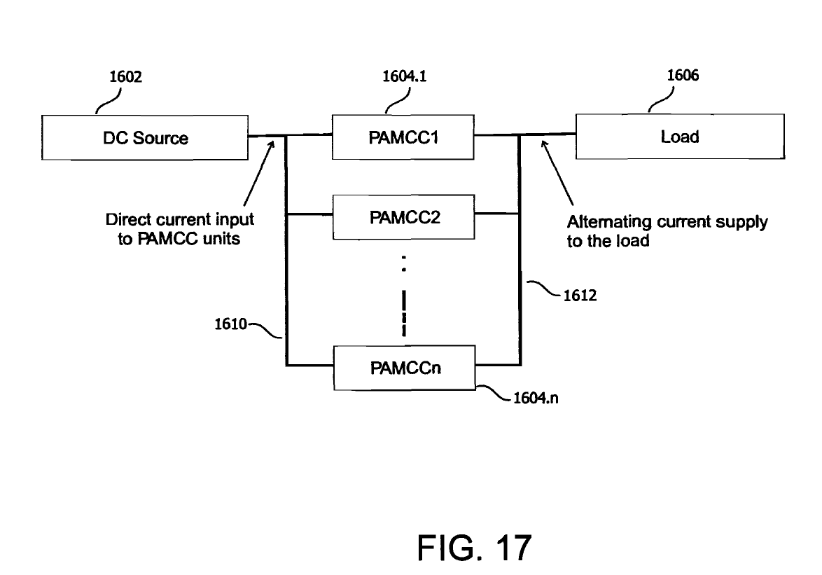

FIG. 17 illustrates another alternative topology for a three phase electrical source 102. A DC source 1602 provides current on a bus of lines 1610 to a plurality of PAMCC 1604.1, 1604.n units. The DC source 1602 may be any of a variety of DC current sources, for example a solar panel, a solar panel array, a battery, multiple batteries in parallel (though some of the batteries in parallel may be formed by batteries in series), or a power supply providing DC current from an AC line source. As previously disclosed hereinbefore, the current outputs of the PAMCCs 1604.1, 1604.n, are summed out of phase on a bus 1612 to provide AC power to a load 1606. The load 1606 may be an external grid.

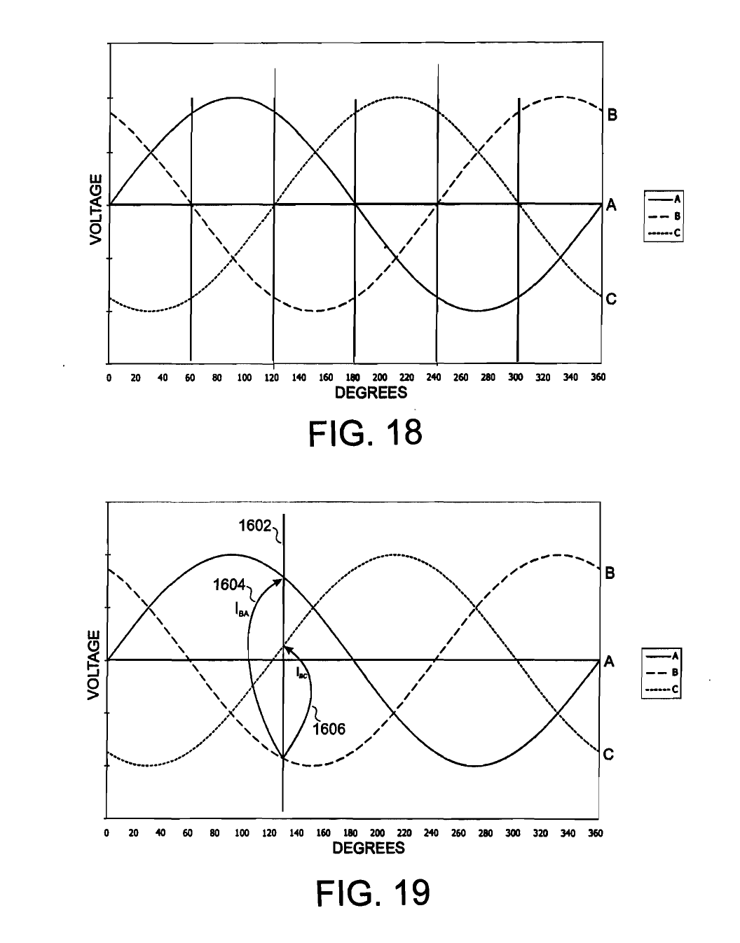

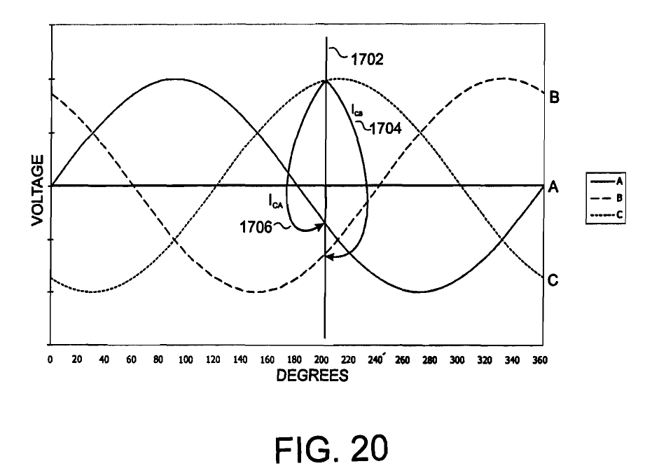

Using the PAMCC technology, three phase current may alternatively be produced from DC input current, such as from a solar power array. FIG. 18 illustrates the phase relationship between the phases of a three phase system. FIG. 18 and the following graphs, FIGS. 19 and 20 indicate a vertical axis representing voltage, but for a fixed voltage system the axis would also represent current. The three phases are arbitrarily referred to as phases A, B, and C. Three phase circuits may be configured in a “wye” arrangement or a “delta” arrangement. In a wye circuit, the common node is referred to as “N”. As can be seen, the phases are 120 degrees apart. Note that in any given sixty degree window, two phases will be of the same polarity and the third phase will be the opposite polarity.

For a commercial power generator, the generation system is connected to a low impedance three phase grid, wherein the power (therefore, the voltage-current product) are kept the same. For the various embodiments the power in each of the three phases may be equal.

In a system according to the present invention, current may be driven from a common reference of a given polarity to two terminals of the opposite polarity. Looking to FIG. 19, at a point in time of a grid cycle 1602, Vb is a negative voltage and Va, Vc are both positive voltages. To maintain the desired voltages on phases A and B, current Iba 1604 is driven from Phase B to Phase A, then current Ibc 1606 is driven from Phase B to Phase C. Note that positive current is being driven into positive voltage nodes, therefore the power delivered is positive.

Now looking to FIG. 20, at time 1702 Phase C is a positive voltage and Phases A and B are negative voltages. We therefore select Phase C as the common reference, and drive current Icb 1704 from Phase C to Phase B, then drive current Icb 1706 from Phase C to Phase A.

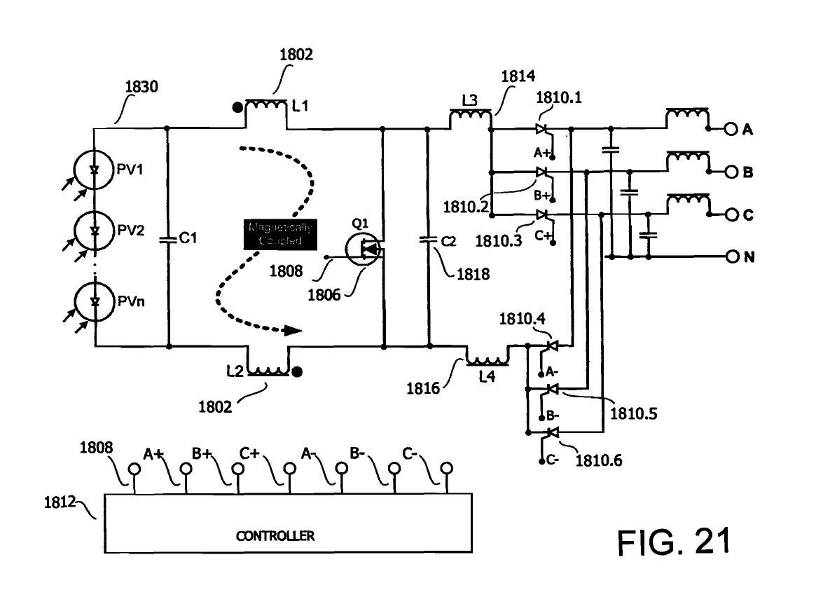

FIG. 21 is an example of a circuit according to the present invention, wherein the circuit can be configured from time to time to charge up the coils L1 1802 and L2 1804, in a manner similar to that of coils L1 406 and L2 406 discussed above with reference to FIG. 5. The charge in the coils may then be provided to two output terminals as previously described above with reference to FIGS. 19 and 20. The output stage may be in a wye configuration.

In the example of FIG. 21, six thyristors 1810.1, 1810. 2, 1810.3, 1810.4, 1810.5, and 1810.6 (herein after referred to generally as “1810.n”) provide ON/OFF switching in each of six lines to three output terminals (A, B, C). Control signals to the control gates of the thyristors 1810.n are provided by a controller 1812, wherein the controller 1812 includes logic, a programmed microprocessor, or other means for making decisions and generating the appropriate control signals in accordance with the method of the present invention. In some embodiments MOSFETs are used instead of the thyristors 1810.n. Thyristors generally are slower than MOSFETs. In embodiments using thyristors 1810.n, some embodiments provide a smoothing circuit comprising a coil L3 1814 in the high side branch, a coil L4 1816 in the low side branch, and a capacitor C2 1818. The smoothing circuit 1814, 1816, 1818 provides for a longer time period of current pulses, thereby accommodating the slower response times of thyristors.

A switch Q1 1806, typically a MOSFET, is driven ON in response to a signal on line 1808 from the controller 1812, thereby charging the coils L1 1802 and L2 1804 with current from the photovoltaic panel 1830, as described in the operation of the two-phase above. Though discussed in relation to an example MOSFET, switch Q1 1806 may be any known type of technology capable of performing a switching function, including relays, transistors, bi-polar transistors, insulated-gate bipolar transistors (IGBTs), silicon carbide MOSFETs, Gallium nitride transistors, thyristors, NMOS FETs, series connected MOSFETs, thyristor emulators, and diodes in series with IGBTs to name just a few. Referring to the example of FIG. 16, the controller 1812 may be configured to drive current from Phase B to Phase A, then from Phase B to Phase C.

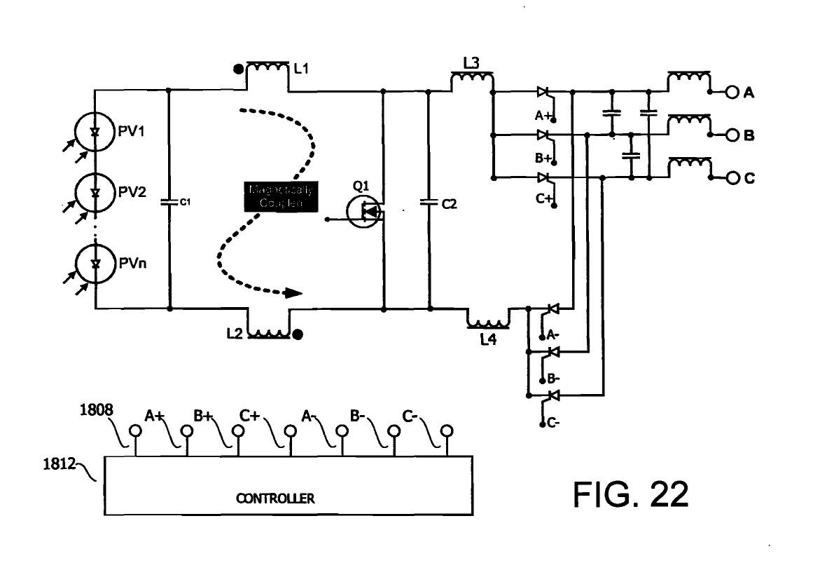

FIG. 22 presents an embodiment of the present invention similar to that of FIG. 21 but with the output stage configured as a delta circuit.

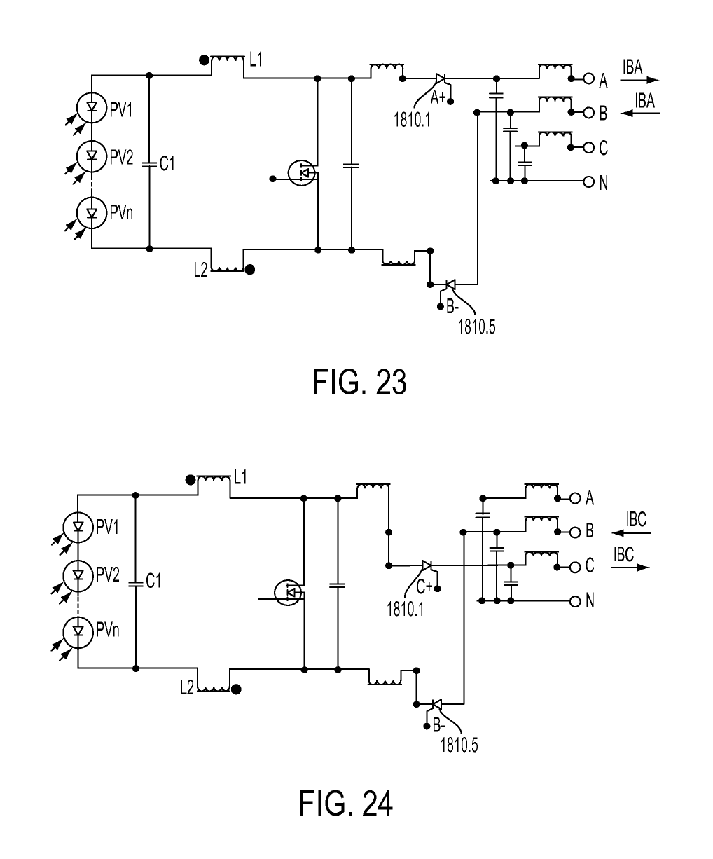

To illustrate the commutation effect of the thyristors, FIG. 23 and FIG. 24 show only those thyristors that are turned on, and unpowered lines are removed for clarity. Referring to FIG. 23, controller 1812 may turn on thrystor B− 1810.5 and thyristor A+ 1810.1 with transistor Q1 1806 off. Coils L1 1802 and L2 1804 may no longer be connected through the transistor Q1 1806, therefore their current may be provided into terminal A, and terminal B may be the return path. When terminals B and A have been connected for a predetermined time, thyristor A+ 1810.1 may be turned off and thyristor C+ 1810.3 may be turned on, as shown in FIG. 24.

The process as just described is repeated so long as the phases are within a given sixty degree range. In each case, the thyristor first turned ON will result in the greater voltage change from the common reference. After a time, the thyristor that will result in the lower voltage change is turned ON. Therefore, it can be seen that during a given sixty degree period the common reference point is always the same, and during the first thirty degrees one phase is farther away from the common reference, and during the second thirty degrees the other phase is farther away. To include all twelve thirty degree time phases, we can determine the following thyristors to turn ON first, then second for each window per Table 2.

TABLE 2

| Phase> | 0-30 | 30-60 | 60-90 | 90-120 | 120-150 | 150-180 | 180-210 | 210-240 | 240-270 | 270-300 | 300-330 | 330-360 |
|---|---|---|---|---|---|---|---|---|---|---|---|---|
| T_{S1} | C−B+ | C−A+ | A+C− | A+B− | B−A+ | B−C+ | C+B− | C+A− | A−C+ | A−B+ | B+A− | B+C− |
| T_{S2} | C−A+ | C−B+ | A+B− | A+C− | B−C+ | B−A+ | C+A− | C+B− | A−B+ | A−C+ | B+C− | B+A− |

In Table 2 the annotations refer to the thyristor labels per FIG. 22. For example, “C-B+” indicates to turn on thyristors C− 1810.6 and B+ 1810.2. TS1 is the first time period, TS2 is the second time period, as discussed further below.

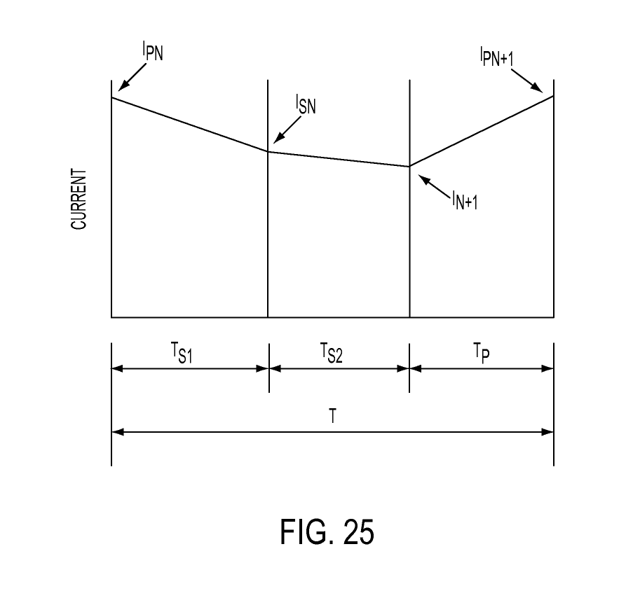

FIG. 25 defines certain time periods and annotation convention, to be used in the following discussion. During time period TS1, current may be driven at an initial value of IPN from the common reference to the first (greater difference in voltage, as previously discussed) power rail, the current diminishing to ISN at the end of the time period TS1. At that point the next set of thyristors may be turned on (see Table 2) for a time TS2. The current initially has a value of ISN, and a value of IN+1 at the end of the time period TS2. All thyristors may then be turned OFF, and the transistor Q1 1806 may be driven on by the controller 1812, which provides a signal on line 1808. With Q1 1806 turned ON, the coils L1 1802 and L2 1804 may be recharged by the photovoltaic panel 1830. The period T is a fixed time period, therefore:

T_{P}=T−T_{S1}−T_{S2}

Time period T should be related to a higher frequency than the frequency of the grid being powered. In one embodiment the period T is related to a frequency of 504 times the frequency of the grid, wherein the grid frequency is 60 Hz in the United States and is 50 Hz in most of the rest of the world. The time periods of FIG. 25 can be determined in the following manner:

$${I}_{sn} = {I}_{pn} - \frac{( {V}_{01} - {V}_{i} )}{L} {T}_{s 1}$$

where V_{O1} is defined as the open circuit voltage for the power rail that is to be driven first, Vi is the voltage from the photovoltaic panel 1830, and L is the equivalent inductance of the two coils L1 1802 and L2 1804, including the effect of mutual inductance. Similarly, the current at the next time period may be calculated from:

$${I}_{n + 1} = {I}_{sn} - \frac{( {V}_{02} - {V}_{i} )}{L} {T}_{s 2}$$

where VO2 is defined as the open circuit voltage for the power rail that is to be driven second. Referring to FIG. 25,

$$\begin{matrix}{I}_{pn + 1} = {I}_{n + 1} + {V}_{i} \frac{( T - {T}_{s 1} - {T}_{s 2} )}{L} \\ = {I}_{pn} - \frac{( {V}_{01} - {V}_{i} )}{L} {T}_{s 1} - \frac{( {V}_{02} - {V}_{i} )}{L} {T}_{s 2} + {V}_{i} \frac{( T - {T}_{s 1} - {T}_{s 2} )}{L}\end{matrix}$$

Expanding terms from the equation yields:

$${I}_{pn + 1} = {I}_{pn} + \text{?}$$

$$\text{?} \text{indicates text missing or illegible when filed}$$

which after dropping out cancel terms results in:

$${I}_{pn + 1} = {I}_{pn} + \frac{( {V}_{i} T - {V}_{01} {T}_{s 1} - {V}_{02} {T}_{s 2} )}{L} .$$

The average current during the time period TS1 may be calculated by:

$${i}_{oave 1} = {K}_{R} {V}_{01} = \frac{( {I}_{ph} + {I}_{sn} )}{2} \frac{{T}_{s 1}}{T} = {I}_{pn} \frac{{T}_{s 1}}{T} - \frac{( {V}_{01} - {V}_{i} )}{2 L} \frac{{T}_{s 1}^{2}}{T}$$

where KR is a conductance term controlled by a slow “outer loop” to provide the current needed. Rewriting terms yields:

$$\frac{{V}_{01} - {V}_{i}}{2 L} \frac{{T}_{s 1}^{2}}{T} - \frac{{I}_{pn}}{T} {T}_{s 1} + {i}_{oave 1} = φ$$

By defining the following terms

$$\frac{{V}_{01} - {V}_{i}}{2 L} \frac{1}{T} = A 1 ; \frac{{I}_{pn}}{T} = B 1 ; {i}_{oave 1} = C 1$$

the following equation can be solved to determine TS1:

$${T}_{s 1 ( 1 , 2 )} = \frac{B 1 \pm \sqrt{( B {1}^{2} - 4 A 1 C 1 )}}{2 A 1} .$$

### Similarly for TS2:

$$\begin{matrix}{i}_{oave 2} = {K}_{R} {V}_{02} \\ = \frac{( {I}_{sn} + {I}_{n + 1} )}{2} \frac{{T}_{s 2}}{T} \\ = {I}_{pn} \frac{{T}_{s 2}}{T} - \frac{( {V}_{01} - {V}_{i} ) {T}_{s 1} {T}_{s 2}}{LT} - \frac{( {V}_{01} - {V}_{i} ) {T}_{s 2}^{2}}{2 LT}\end{matrix}$$

$$\frac{{V}_{01} - {V}_{i}}{2 LT} {T}_{s 2}^{2} - \frac{{I}_{pn} - \frac{1}{L} ( {V}_{01} - {V}_{i} ) {T}_{s 1}}{T} \times {T}_{s 2} + {i}_{oave 2} = φ$$

As before we define the terms:

$$\frac{{V}_{02} - {V}_{i}}{2 LT} = A 2 ; \frac{{I}_{pn} - \frac{1}{L} ( {V}_{01} - {V}_{i} ) {T}_{s 1}}{T} = B 2 ; {i}_{oave 2} = C 2 ;$$

$$then$$

$${T}_{s 2 ( 1 , 2 )} = \frac{B 2 \pm \sqrt{( B {2}^{2} - 4 A 2 C 2 )}}{2 A 2}$$

$${i}_{iave} = {i}_{oave 1} + {i}_{oave 2} + \frac{( {I}_{n + 1} + {I}_{pn + 1} )}{2} \frac{( T - {T}_{s 1} - {T}_{s 2} )}{T}$$

$${i}_{iave} = {i}_{oave 1} + {i}_{oave 2} + ( {I}_{pn} + \frac{1}{L} ( \begin{matrix}- {V}_{01} {T}_{s 1} - {V}_{02} {T}_{s 2} + \\ {V}_{i} \frac{( T + {T}_{s 2} - {T}_{s 1} )}{2}\end{matrix} ) ) ( 1 - \frac{{T}_{s 1} + {T}_{s 2}}{T} )$$

$${V}_{in + 1} - {V}_{i} = Δ {V}_{i} \frac{1}{1 + \frac{{R}_{PV} {C}_{i}}{T}} ( {E}_{PV -} {R}_{PV} {i}_{iave} - {V}_{in} )$$

where EPV and RPV are the Thevenin Equivalent of the photovoltaic panel.

A solar powered current source will eventually be unable to provide enough current to meet the demand of the load as the sun sets or storm clouds move in. As the target current approaches the maximum available the target current is gradually reduced to minimize THD.

The foregoing method descriptions are provided merely as illustrative examples and are not intended to require or imply that the steps of the various algorithms and embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to control the PAMCC switches and implement the various algorithms may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a computer-readable medium. The steps of a method or algorithm disclosed herein may be embodied in a processor-executable software module which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc, where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the widest scope consistent with the following claims and the principles and novel features disclosed herein.

What is claimed is:

1. A three-phase to two-phase electrical power converter, comprising:
a three phase induction motor configured to be coupled to a three phase electrical power supply, the three phase induction motor comprising:
three windings wired together in a delta configuration to create three winding nodes, wherein each of the three winding nodes is configured to be coupled to one of the three phase outputs of the three phase electrical power supply; and
a rotor magnetically coupled to the three windings, the rotor configured such that magnetic fields generated by the three windings will cause the rotor to rotate;
a first electrical lead connected to one of the three winding nodes and configured to be connected to a two-phase load; and
a second electrical lead connected to a different one of the three winding nodes than the first electrical lead and configured to be connected to the two-phase load.

2. The three-phase to two-phase electrical power converter of claim 1, further comprising a shaft coupled to the rotor, the shaft being coupled to one of a flywheel and a mechanical load.

3. A two-phase power generation system, comprising:
a three phase electrical power source comprising:
a first output terminal configured to output a first phase of three phase electrical power;
a second output terminal configured to output a second phase of three phase electrical power; and
a third output terminal configured to output a third phase of three phase electrical power;
a three phase induction motor comprising:
a first winding;
a second winding connected to the first winding, wherein the connection between the first winding and the second winding creating a first winding node;
a third winding, wherein a one end of the third winding is connected to the first winding creating a second winding node and an opposite end of the third winding is connected to the second winding creating a third winding node; and
a rotor magnetically coupled to the first, second, and third windings, the rotor configured such that magnetic fields generated by the first, second, and third windings will cause the rotor to rotate,
wherein the first winding node is connected to the first output terminal of the three phase electrical power source, the second winding node is connected to the second output terminal of the three phase electrical power source, and the third winding node is connected to the third output terminal of the three phase electrical power source;
a first electrical lead connected to the first winding node;
a first load switch, an input terminal of the first load switch connected to the first electrical lead;
a second electrical lead connected to the second winding node;
a second load switch, an input terminal of the second load switch connected to the second electrical lead;
a two-phase load connected between an output terminal of the first load switch and an output terminal of the second load switch; and
a load switch controller coupled to a control gate of the first load switch and a control gate of the second load switch, wherein the load switch controller is configured to provide control signals to the control gates of the first and second load switches so as to selectively couple the two-phase load to the three phase induction motor.

4. The two-phase power generation system of claim 3, further comprising a shaft coupled to the rotor, the shaft being coupled to one of a flywheel and a mechanical load.

5. The two-phase power generation system of claim 3, wherein the three phase electrical power source is a solar power system, comprising:
a plurality of photovoltaic panels each configured to output direct electrical current from output leads when exposed to light; and
a plurality of pulse amplitude modulated current converters (“PAMCCs”) each connected to the direct electrical current output leads of one of the plurality of photovoltaic panels, each of the plurality of PAMCCs comprising input terminals, first, second, and third PAMCC output terminals, and a controller configured to perform operations comprising outputting a first pulse amplitude modulated current pulse at a first phase from the first PAMCC output terminal, outputting a second pulse amplitude modulated current pulse at a second phase from the second PAMCC output terminal, and outputting a third pulse amplitude modulated current pulse at a third phase from the third PAMCC output terminal,
wherein the first PAMCC output terminal of each PAMCC is electrically connected in parallel with the first PAMCC output terminals of others of the plurality of PAMCCs to form the first output terminal, the second PAMCC output terminal of each PAMCC is electrically connected in parallel with the second PAMCC output terminals of others of the plurality of PAMCCs to form the second output terminal, and the third PAMCC output terminal of each converter is electrically connected in parallel with the third PAMCC output terminals of others of the plurality of PAMCCs to form the third output terminal, and
wherein the first, second, and third current pulses of at least two of the plurality of PAMCCs are out of phase with respect to the first, second, and third current pulses of each other such that the current pulses of each phase of the plurality of PAMCCs are summed in the system so that a signal modulated onto the pulse output of the converters is demodulated to produce three-phase alternating current output from the solar power system.

6. The two-phase power generation system of claim 3, wherein the three phase electrical power source is a solar power system, comprising:
a plurality of photovoltaic panels; and
a power converter coupled to the photovoltaic panels and configured to convert direct current from the photovoltaic panels into three phase alternating current.
